(19) United States
(12) Patent Application Publication
(10) Pub. No.: US 2015/0306561 A1
(43) Pub. Date: Oct. 29, 2015

(54) Fuel Generation Device and Fuel Cell System Provided with Same

(71) Applicant: KONICA MINOLTA, INC., Chiyoda-ku, Tokyo (JP)

(72) Inventor: Atsuhiro NODA, Chiyoda-ku, Tokyo (JP)

(21) Appl. No.: 14/650,349

(22) PCT Filed: Oct. 11, 2013
(86) PCT No.: PCT/JP2013/077709

§ 371 Date: Jun. 8, 2015

(30) Foreign Application Priority Data
Dec. 7, 2012 (JP) 2012-268743

(51) Int. Cl. B01J 19/00; H01M 8/10; C01B 3/10; H01M 8/06

(52) U.S. Cl. CPC B01J 19/0053; H01M 8/065; H01M 8/10; C01B 3/10; H01M 8/0606; B01J 2219/00162

(57) ABSTRACT

A fuel generation device is provided with a gas inlet, a gas outlet, a fuel generation member that generates the fuel gas by an oxidizing reaction with an oxidizing gas, an accommodation part that is provided between the gas inlet and the gas outlet and accommodates the fuel generation member, and an exhaust valve provided between the accommodation part and the gas outlet. Further, by cyclically varying the opening angle of the exhaust valve at opening angles including a first opening angle and a second opening angle smaller than the first opening angle, the increase in pressure in the accommodation part is greater in the case where the opening angle of the exhaust valve is at the second opening angle than the case where the opening angle of the exhaust valve is at the first opening angle.

### TECHNICAL FIELD

The present invention relates to a fuel generating device for generating fuel gas as a reductant gas through an oxidation reaction with an oxidant gas, and also relates a fuel cell system incorporating such a fuel generating device.

### BACKGROUND ART

In a fuel cell, a single cell is typically composed of a solid polymer electrolyte membrane comprising a solid polymer ion exchange membrane, or a solid oxide electrolyte membrane comprising yttria-stabilized zirconia (YSZ), or the like held between, from opposite sides, a fuel electrode (anode) and an oxidant electrode (cathode). In addition, there are provided a fuel gas flow passage through which fuel gas (e.g., hydrogen) is supplied to the fuel electrode and a oxidant gas flow passage through which oxidant gas (e.g., oxygen or air) is supplied to the oxidant electrode. Through these flow passages, the fuel gas and the oxidant gas are supplied to the fuel electrode and the oxidant electrode respectively, and thereby electric power is generated.

Owing to their working principle, fuel cells allow highly efficient extraction of electrical energy; thus, they not only help save energy, but count as an ecofriendly means of power generation, and are therefore expected to be crucial for solving energy and environmental problems on a global scale.

### LIST OF CITATIONS

### Patent Literature

Patent Document 1: Ex-PCT JP-A-H11-501448

Patent Document 2: WO 2012/043271

Patent Document 3: WO 2012/026219

### SUMMARY OF THE INVENTION

### Technical Problem

Patent Documents 1 to 3 disclose secondary battery-type fuel cell systems comprising a solid oxide fuel cell combined with a hydrogen generating member which generates hydrogen through an oxidation reaction and which is regenerable through a reduction reaction. In these secondary battery-type fuel cell systems, the hydrogen generating member generates hydrogen during power generating operation of the system, and the hydrogen generating member is regenerated during charging operation of the system.

In one configuration of the hydrogen generating member, for example, fine particles containing, as a base material, a metal that generates hydrogen through an oxidation reaction and that is regenerable through a reduction reaction are stuck together with gaps left behind that are barely large enough to allow passage of gas; in another configuration, such fine particles are formed into pellet-form grains, and with a large number of those grains, a space is filled. Due to structural reasons, a hydrogen generating member formed in this way often suffers from, when supplied with gas, uneven pressure losses, with a large pressure loss in some parts compared with a small pressure loss elsewhere.

Thus, when gas is supplied to the hydrogen generating member, the gas does not pervade all parts of the hydrogen generating member, but flows concentratedly through parts of the hydrogen generating member where the pressure loss is small for structural reasons. This hampers effective use of parts of the hydrogen generating member where the pressure loss is large for structural reasons, resulting in a reduced amount of fuel gas generated; moreover, concentrated use of parts of the hydrogen generating member where the pressure loss is small for structural reasons results in concentrated deterioration of parts of the hydrogen generating member where the pressure loss is small for structural reasons, resulting in lower durability of the hydrogen generating member as a whole. This inconvenience is particularly notable in a case where the hydrogen generating member is so configured that a space is filled with a large number of pellet-form grains, because then the filling cannot help being random, and this means larger structural variations.

Against the background discussed above, an object of the present invention is to provide a fuel generating device that generates a large amount of fuel gas and that offers high durability, and to provide a fuel cell system incorporating such a fuel generating device.

### Means for Solving the Problem

To achieve the above object, according to one aspect of the present invention, a fuel generating device which generates fuel gas as a reductant gas through an oxidation reaction with an oxidant gas includes: a gas inflow port through which the oxidant gas is supplied from the outside; a gas outflow port through which the fuel gas is supplied to the outside; a fuel generating member which generates the fuel gas through the oxidation reaction with the oxidant gas; a housing which is provided between the gas inflow port and the gas outflow port and which houses the fuel generating member; and an exhaust valve which is provided between the housing and the gas outflow port. Here, the degree of opening of the exhaust valve is varied periodically among a different degrees of opening including a first degree of opening and a second degree of opening smaller than the first degree of opening such that a rise in the pressure inside the housing due to the oxidant gas being supplied to the housing via the gas inflow port from the outside is larger when the exhaust valve has the second degree of opening than when the exhaust valve has the first degree of opening.

### Advantageous Effects of the Invention

With a fuel generating device according to one aspect of the present invention, the rise in the pressure in the housing due to the oxidant gas being supplied to the housing via the gas inflow port from the outside is larger when the exhaust valve has the second degree of opening than when the exhaust valve has the first degree of opening. Accordingly, when the exhaust valve has the second degree of opening, the oxidant gas more easily pervades parts of the fuel generating member where the pressure loss is large for structural reasons. This allows effective use of parts of the fuel generating member where the pressure loss is large for structural reasons; it is thus possible to generate an increased amount of fuel gas, to prevent concentrated deterioration of parts of the hydrogen generating member where the pressure loss is small for structural reasons, and to enhance the durability of the fuel generating device.

With a fuel cell system according to another aspect of the present invention, owing to the provision of the fuel generating device according to one aspect of the present invention, the increased amount of fuel gas generated by the fuel generating device results in an increased battery capacity of the fuel cell system, and the enhanced durability of the fuel generating device results in an enhanced durability of the fuel cell system.

### BRIEF DESCRIPTION OF DRAWINGS

FIG. 1 is a schematic diagram showing an outline configuration of a secondary battery-type fuel cell system according to a first embodiment of the present invention;

FIG. 2 is a schematic diagram showing a configuration of a fuel generating device according to the first embodiment;

FIG. 3 are diagrams showing a method of fabricating a sub-housing;

FIG. 4 are diagrams showing a flow of gas in a fuel generating device according to the first embodiment;

FIG. 5 is a chart showing the state of an exhaust valve, the average pressure in a housing, and the amount of hydrogen supplied in the first embodiment;

FIG. 6 are a chart showing the state of an exhaust valve, the average pressure in a housing, and the amount of hydrogen supplied in a comparative example;

FIG. 7 is a chart showing the amounts of hydrogen supplied in the first embodiment and in a comparative example;

FIG. 8 is a schematic diagram showing an outline configuration of a secondary battery-type fuel cell system according to a second embodiment of the present invention;

FIG. 9 is a chart showing the amounts of hydrogen supplied in the second embodiment and in the first embodiment;

FIG. 10 is a schematic diagram showing a configuration example of a diffuser;

FIG. 11 is a schematic diagram showing a modified example of a secondary battery-type fuel cell system according to the second embodiment of the present invention;

FIG. 12 is a chart showing the state of an exhaust valve, the average pressure in a housing, and the amount of hydrogen supplied in a third embodiment of the present invention;

FIG. 13 is a schematic diagram showing a configuration of a fuel generating device according to a fourth embodiment of the present invention;

FIG. 14 is a schematic diagram showing a modified example of a fuel generating device according to the fourth embodiment;

FIG. 15 is a schematic diagram showing a modified example of a fuel generating device according to a fifth embodiment of the present invention;

FIG. 16 is a chart showing the state of an exhaust valve and the state of a suction valve in the fifth embodiment;

FIG. 17 is a chart showing the amount of hydrogen supplied in the fifth embodiment; and

FIG. 18 is a schematic diagram showing a modified example of a fuel generating device.

### DESCRIPTION OF EMBODIMENTS

Embodiments of the present invention will be described below with reference to the accompanying drawings. None of the embodiments presented below is meant to limit the present invention in any way.

### First Embodiment

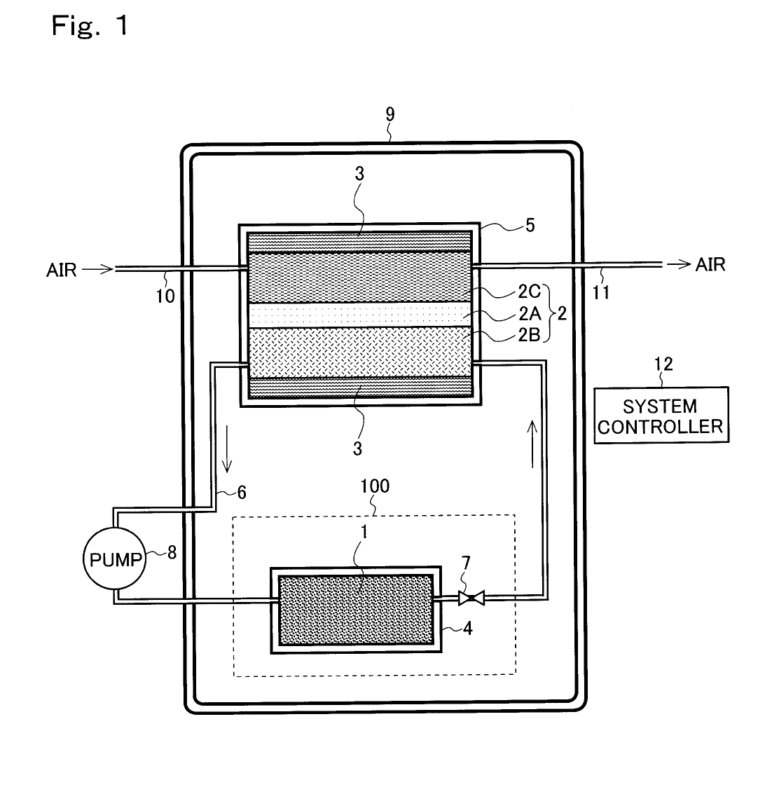

An outline configuration diagram of a secondary battery-type fuel cell system according to a first embodiment of the present invention is shown in FIG. 1. The secondary battery-type fuel cell system according to this embodiment includes a fuel generating member 1, a fuel cell portion 2, a heater 3 for heating the fuel cell portion 2, a housing 4 for housing the fuel generating member 1, a container 5 for housing the fuel cell portion 2 and the heater 3, piping 6 for circulating gas between the fuel generating member 1 and the fuel cell portion 2, an exhaust valve 7 provided between the fuel generating member 1 and the fuel gas inflow side of the fuel cell portion 2, a pump 8 for forcibly circulating gas between the fuel generating member 1 and the fuel cell portion 2, a heat-insulated container 9, piping 10 for supplying air to an air electrode 2C of the fuel cell portion 2, piping 11 for exhausting air from the air electrode 2C of the fuel cell portion 2, and a system controller 12 for controlling the entire system. The heat-insulated container 9 houses the housing 4, the container 5, and part of each of the piping 6, 10, and 11. A fuel generating device 100 is constituted by the fuel generating member 1, the housing 4, the exhaust valve 7, and part of the piping 6.

For the sake of simple illustration, power lines for delivering electric power, control lines for delivering control signals, and the like are omitted from illustration. As necessary, a heater may be provided around the fuel generating member 1. Also, as necessary, a temperature sensor or the like may be provided around the fuel generating member 1 and around the fuel cell portion 2. Instead of the pump 8, any other type of circulator may be used, such as a compressor, a fan, or a blower.

Usable as the fuel generating member 1 is, for example, a member which contains a metal as a base material, has a metal or a metal oxide added to the surface of the base material, generates fuel gas (e.g., hydrogen) through an oxidation reaction with an oxidant gas (e.g., water vapor (steam)), and is regenerable through a reduction reaction with a reductant gas (e.g., hydrogen). Examples of the metal as the base material include, for example, Ni, Fe, Pd, V, Mg, and alloys based on any of those. Among others, Fe is preferred because it is inexpensive and easy to work. Examples of the added metal include Al, Rh, Pd, Cr, Ni, Cu, Co, V, and Mo. Examples of the added metal oxide include SiO₂ and TiO₂. It should be noted that the metal as the base material is not identical with the added metal. In this embodiment, used as the fuel generating member 1 is one containing Fe as a principal component.

A fuel generating member containing Fe as a principal component can generate hydrogen as fuel gas (reductant gas) by consuming water vapor as an oxidant gas through, for example, an oxidation reaction expressed by formula (1) below.

4H₂O+3Fe→4H₂+Fe₃O₄ (1)

As the oxidation reaction of iron expressed by formula (1) above progresses, more and more iron turns into iron oxide, and the amount of remaining iron decreases. On the other hand, the fuel generating member 1 can be regenerated through a reaction reverse to that expressed by formula (1) above, i.e., through a reduction reaction expressed by formula (2) below. Incidentally, the oxidation reaction of iron expressed by formula (1) and the reduction reaction expressed by formula (2) below can both take place at temperatures as low as less than 600° C.

4H₂+Fe₃O₄→3Fe+4H₂O (2)

For increased reactivity, it is preferable to give the fuel generating member 1 as large a surface area as possible per unit volume. One way to increase the surface area of the fuel generating member 1 per unit volume is, for example, by breaking the principal component of the fuel generating member 1 into fine particles and molding the fine particles together. The breaking into fine particles can be achieved, for example, by grinding by use of a ball-end mill or the like. The surface area of the fine particles can be further increased by developing cracks in the fine particles through a mechanical or other process, or by coarsening the surface of the fine particles by treatment with an acid or with an alkali or by blasting.

For example, in one configuration of the fuel generating member 1, the fine particles are formed into pellet-form grains, and with a large number of those grains, a space is filled; in another configuration, the fine particles are stuck together with gaps left behind that are barely large enough to allow passage of gas. Irrespective of the configuration of the fuel generating member 1 that is housed in the housing 4, gas will not pervade the entire fuel generating member 1; that is, for structural reasons, it is inevitable that, to a greater or lesser extent, the pressure loss is small in some parts of the fuel generating member 1 and large in other parts.

As shown in FIG. 1, the fuel cell portion 2 has an MEA structure (membrane-electrode assembly) in which a fuel electrode 2B and an air electrode 2C, the latter being an oxidant electrode, are bonded respectively to opposite sides of an electrolyte membrane 2A. Although FIG. 1 illustrates a structure with a single MEA, a plurality of MEAs may be provided, or a plurality of MEAs may be arranged in a stacked structure.

The electrolyte membrane 2A can be formed of, for example, a solid oxide electrolyte comprising yttria-stabilized zirconia (YSZ), or a solid polymer electrolyte such as Nafion (a trademark of DuPont), a cation-conducting polymer, or an anion-conducting polymer. This, however, is not meant as any limitation; any material that offers the properties of an electrolyte in a fuel cell can be used, such as one that passes hydrogen ions, one that passes oxygen ions, or one that passes hydroxide ions. In this embodiment, the electrolyte membrane 2A is formed of a solid oxide electrolyte comprising an electrolyte that passes oxygen ions or hydroxide ions, such as yttria-stabilized zirconia (YSZ).

The electrolyte membrane 2A can be formed, with a solid oxide electrolyte, by CVD-EVD (chemical vapor deposition-electrochemical vapor deposition) and, with a solid polymer electrolyte, by application or the like.

The fuel electrode 2B and the air electrode 2C can each be configured to be composed of a catalyst layer contiguous with the electrolyte membrane 2A and a diffusion electrode stacked on the catalyst layer. The catalyst layer can be formed of, for example, carbon black impregnated with platinum black or a platinum alloy. The diffusion electrode of the fuel electrode 2B can be formed of, for example, carbon paper, a Ni—Fe cermet, or a Ni—YSZ cermet. The diffusion electrode of the air electrode 2C can be formed of, for example, carbon paper, a La—Mn—O compound, or a La—Co—Ce compound. The fuel electrode 2B and the air electrode 2C can each be formed by vapor deposition or the like.

The following description deals with a case where hydrogen is used as fuel gas.

During power generation of the secondary battery-type fuel cell system according to this embodiment, under the control of the system controller 12, the fuel cell portion 2 is electrically connected to an external load (unillustrated). In the fuel cell portion 2, during power generation of the secondary battery-type fuel cell system according to this embodiment, the reaction expressed by formula (3) below takes place at the fuel electrode 2B.

H₂+O²⁻→H₂O+2e⁻ (3)

The electrons generated through the reaction of formula (3) above pass through the external load (unillustrated) and reach the air electrode 2C, where the reaction expressed by formula (4) below takes place.

1/2O₂+2e⁻→O²⁻ (4)

The oxygen ions generated through the reaction of formula (4) above pass through the electrolyte membrane 2A and reach the fuel electrode 2B. Through repetition of the above-described series of reactions, the fuel cell portion 2 performs power generating operation. Moreover, as will be understood from formula (3) above, during power generating operation of the secondary battery-type fuel cell system of this embodiment, at the fuel electrode 2B, H₂ is consumed, and H₂O is generated.

Based on formulae (3) and (4) above, the reaction in the fuel cell portion 2 during power generating operation of the secondary battery-type fuel cell system of this embodiment is expressed by formula (5) below.

H₂+½O₂→H₂O (5)

On the other hand, through the oxidation reaction expressed by formula (1) above, the fuel generating member 1 consumes the H₂O generated at the fuel electrode 2B of the fuel cell portion 2 during power generation of the secondary battery-type fuel cell system according to this embodiment, to generate H₂.

As the oxidation reaction of ion expressed by formula (1) above progresses, more and more iron turns into iron oxide, and the amount of remaining iron decreases; however, through the reduction reaction expressed by formula (2) above, the fuel generating member 1 can be regenerated, and the secondary battery-type fuel cell system according to this embodiment can be recharged.

During charging of the secondary battery-type fuel cell system according to this embodiment, under the control of the system controller 12, the fuel cell portion 2 is connected to an external power supply (unillustrated). In the fuel cell portion 2, during charging of the secondary battery-type fuel cell system according to this embodiment, a reaction reverse to that expressed by formula (5) above, i.e., the electrolysis reaction expressed by formula (6) below, takes place, so that H₂O is consumed and H₂ is generated at the fuel electrode 2B. In the fuel generating member 1, the reduction reaction expressed by formula (2) above takes place, so that the H₂ produced at the fuel electrode 2B of the fuel cell portion 2 is consumed to generate H₂O.

H₂O→H₂+½O₂ (6)

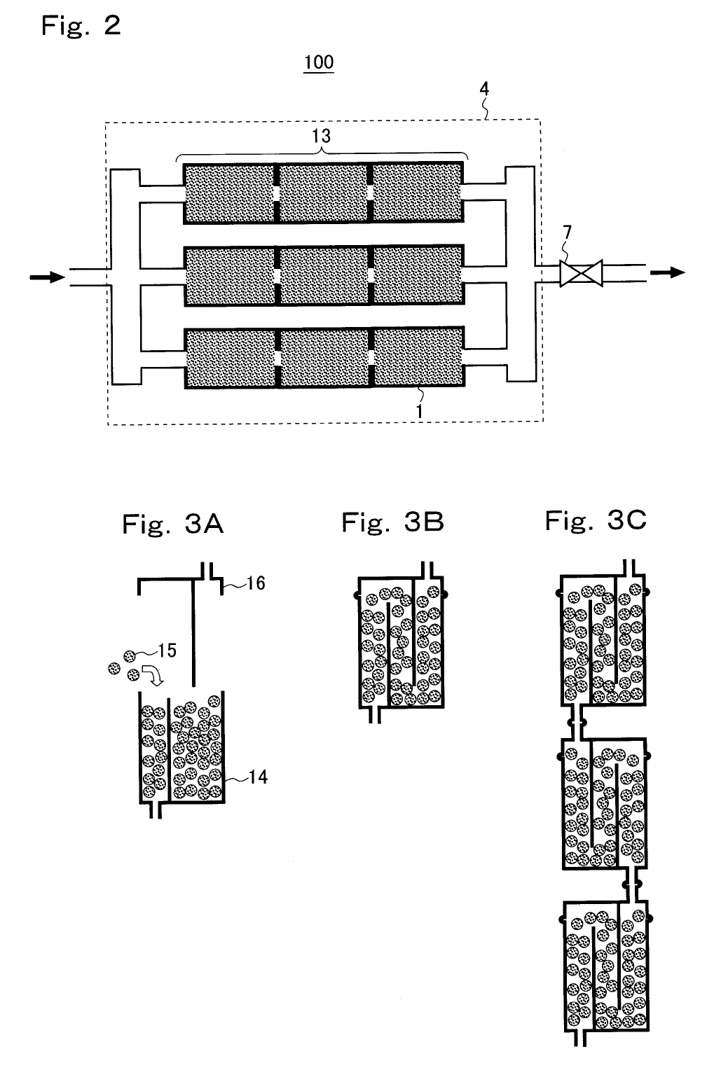

A configuration of the fuel generating device 100 in this embodiment is shown in FIG. 2. In the fuel generating device 100 according to this embodiment, the housing 4 is provided with three sub-housings 13 each housing the fuel generating member 1, the three sub-housings 4 being connected in parallel. For example, according to one method of fabricating the sub-housings 4, as shown in FIG. 3A, a container body 14 is filled with fuel generating member pellets 15, is then covered with a lid 16; then, as shown in FIG. 3B, the lid 16 and the container body 14 are connected together by welding or the like; then, as shown in FIG. 3C, three such containers are connected together in series by welding or the like.

In this embodiment, the degree of opening of the exhaust valve 7 is switched alternately between a degree of opening corresponding to a fully open state and a degree of opening corresponding to a fully closed state. The switching can be achieved, for example, by using, as the exhaust valve 7, a controllable valve and operating it under the control of the system controller 12, or by using a pressure relief valve which remains in a fully closed state when the pressure difference between the inlet and outlet ends is less than a predetermined value and which goes into a fully open state when the difference becomes equal to or greater than the predetermined value.

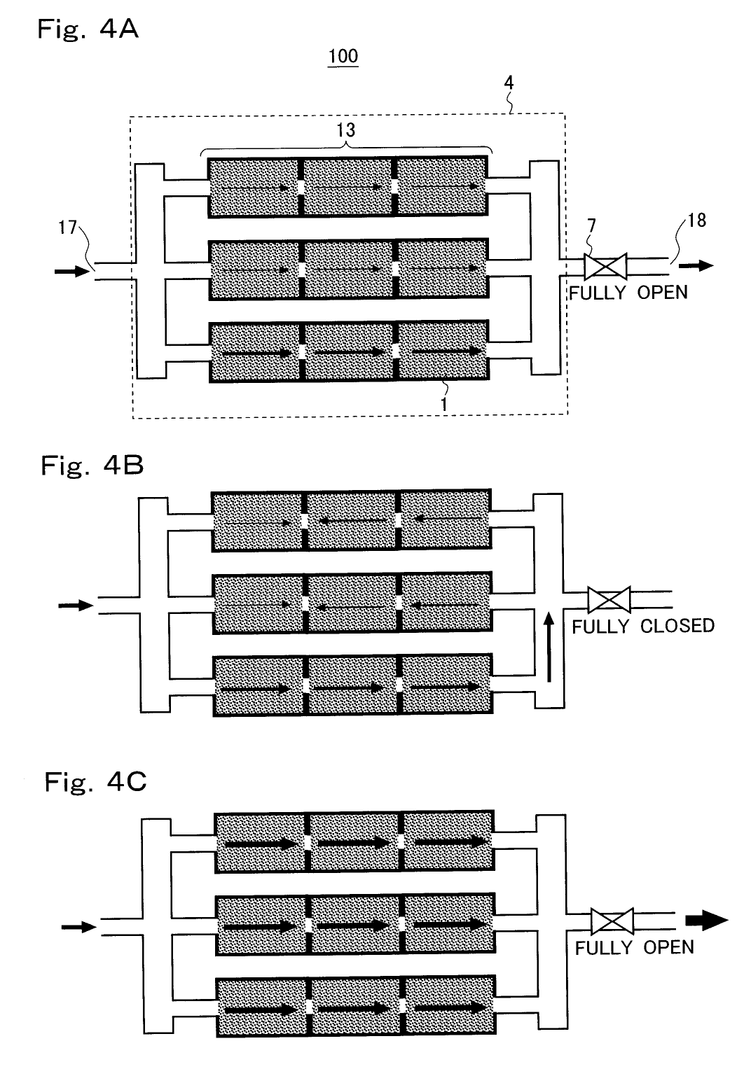

FIG. 4A shows the flow of gas with the exhaust valve 7 in the fully open state. FIG. 4 show a case where the sub-housing 13 illustrated in the lowest row is a sub-housing 13 where the pressure loss is small and the sub-housings 13 illustrated in the upper two rows are sub-housings where the pressure loss is large. The boldness of arrows indicates the gas flow rate, bolder arrows indicating higher gas flow rates. As shown in FIG. 4A, gas flows concentratedly through the sub-housing 13 where the pressure loss is small.

When the exhaust valve 7 is switched from the fully open state to the fully closed state, as shown in FIG. 4B, the gas that has flowed through the sub-housing 13 where the pressure loss is small (illustrated in the lowest row) loses the place to go, and instead flows into the sub-housings 13 where the pressure loss is large (illustrated in the upper two rows). Then, due to the oxidant gas that is supplied to the housing 4 via a gas inflow port 17 from the outside (the gas outflow side of the fuel cell portion 2), the average pressure inside the housing 4 rises.

After the average pressure in the housing 4 has thus risen, and the gas has pervaded the entire housing 4, when the exhaust valve 7 is switched from the fully closed state to the fully open state, as shown in FIG. 4C, the gas is discharged from all the sub-housings 13, and is supplied via a gas outflow port 18 to the outside (the gas inflow side of the fuel cell portion 2). Immediately after the exhaust valve 7 is switched from the fully closed state to the fully open state, the difference between the average pressure inside the housing 4 and the pressure at the outlet side of the exhaust valve 7 is so large that, as indicated by bold arrows in FIG. 4C, gas flows through the sub-housings 13 at a high flow rate.

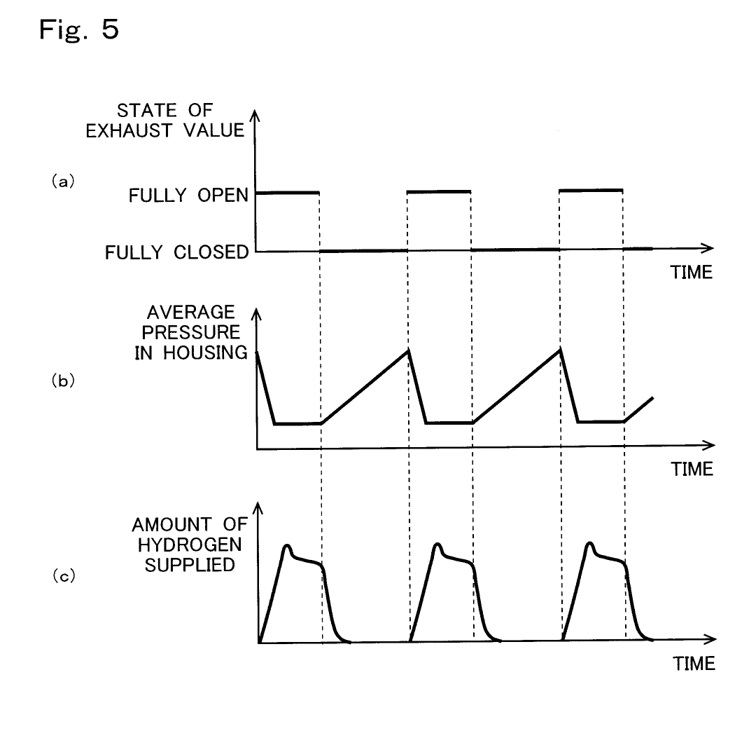

The cycle described above is repeated such that the state of the exhaust valve 7, the average pressure in the housing 4, and the amount of hydrogen supplied via the gas outflow port 18 to the outside are as shown in FIGS. 5(a), 5(b), and 5(c) respectively. The period at which the state of the exhaust valve 7 is switched can be set according to the rated output of the fuel cell system, the amount of the fuel generating member 1, etc. The period is typically set in a range of several seconds to ten and several seconds, but can be of the order of several minutes as the case may be.

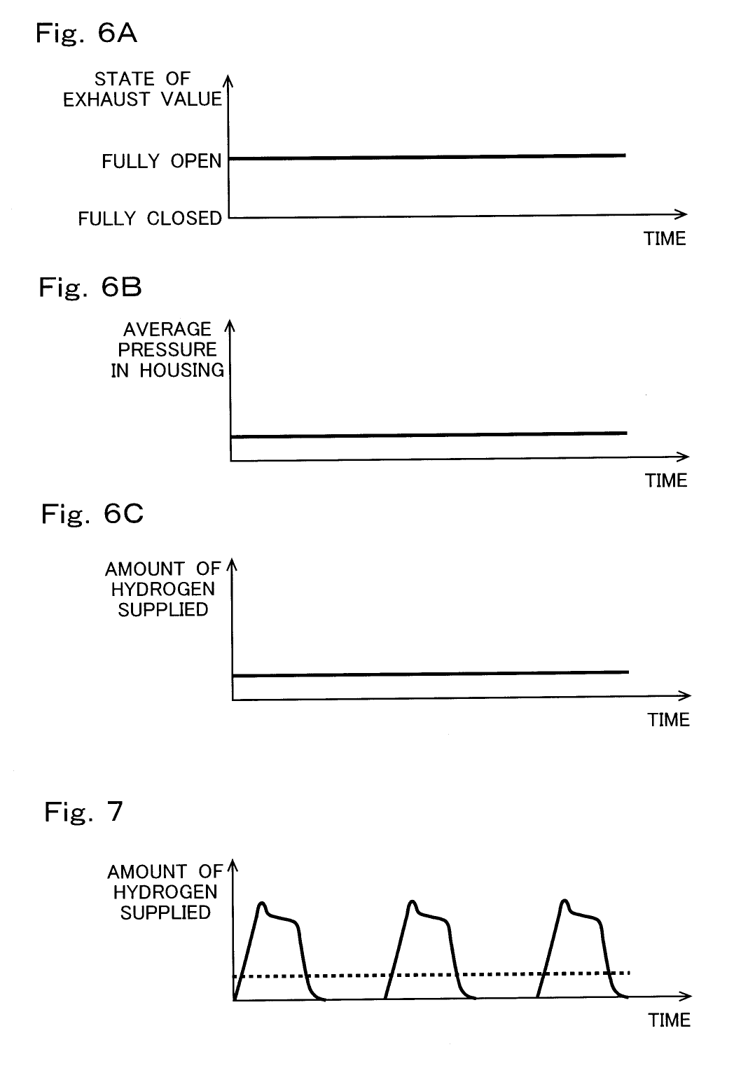

Now, consider, as a comparative example, a case where the exhaust valve 7 is kept in the fully open state all the time, that is, a case equivalent to a configuration with no exhaust valve 7 provided. In this case, the state of the exhaust valve 7, the average pressure in the housing 4, and the amount of hydrogen supplied via the gas outflow port 18 to the outside are as shown in FIGS. 6A, 6B, and 6C respectively.

In FIG. 7, the amount of hydrogen supplied via the gas outflow port 18 to the outside in this embodiment is represented by a solid line, and the amount of hydrogen supplied via the gas outflow port 18 to the outside in the comparative example is represented by a broken line. In this embodiment, even a sub-housing 13 where the pressure loss is large is used effectively; in contrast, in the comparative example, a sub-housing 13 where the pressure loss is large is not used effectively. As a result, as will be seen from FIG. 7, the amount of the fuel generating member 1 that contributes to the oxidation reaction is larger in this embodiment (solid line) than in the comparative example (broken line), and accordingly the total amount of hydrogen supplied via the gas outflow port 18 to the outside is larger in this embodiment than in the comparative example.

In this embodiment, a state where gas flows concentratedly through a sub-housing 13 where the pressure loss is small, i.e., the state shown in FIG. 4A, is not maintained. It is thus possible to prevent concentrated deterioration (e.g., sintering, and dropping-off of fine particles constituting the fuel generating member 1) of the fuel generating member 1 housed in a sub-housing 13 where the pressure loss is small. This helps enhance the durability of the fuel generating device 100.

### Second Embodiment

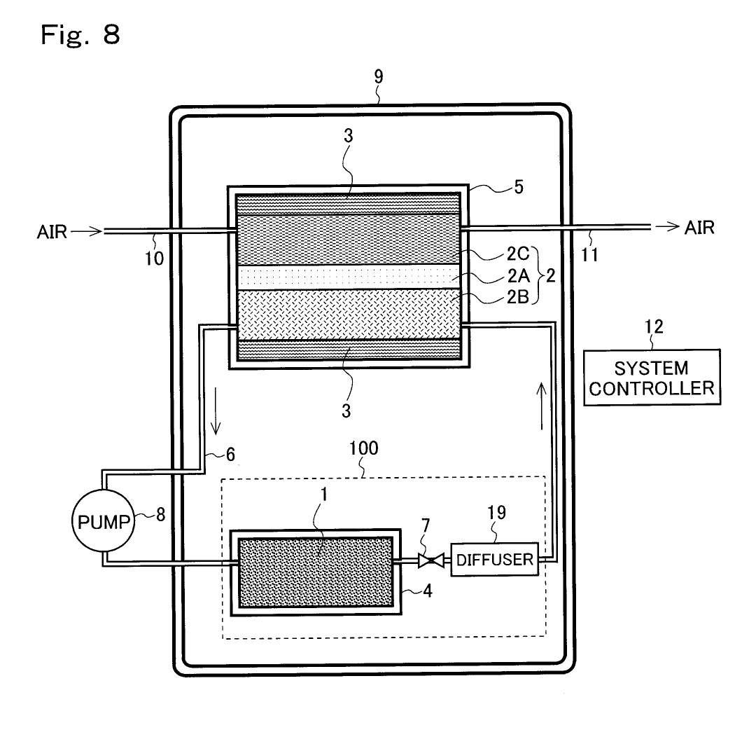

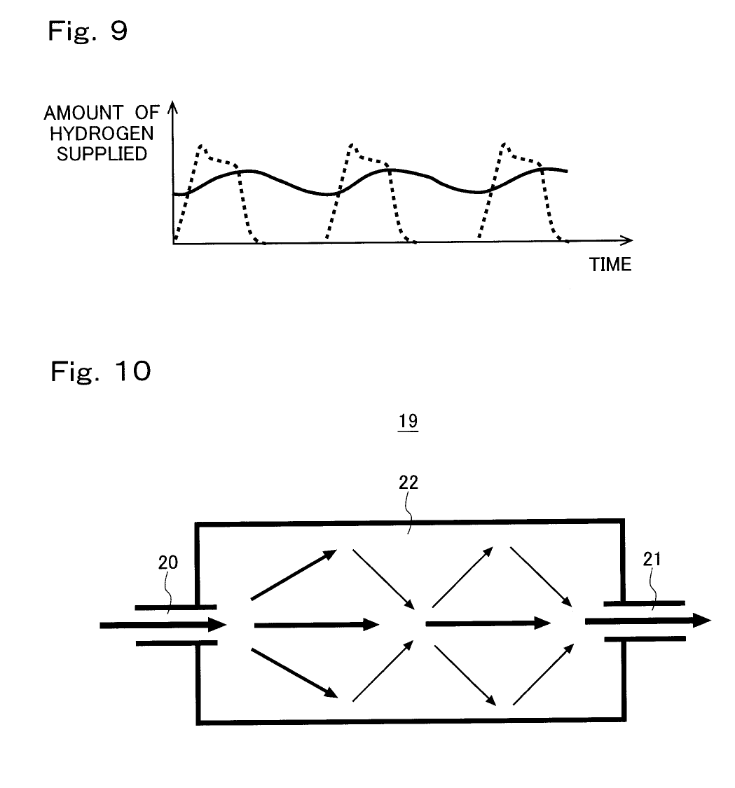

An outline configuration of a secondary battery-type fuel cell system according to a second embodiment of the present invention is shown in FIG. 8. Compared with the secondary battery-type fuel cell system according to the first embodiment, the secondary battery-type fuel cell system according to the second embodiment is further provided with a diffuser 19 for diffusing gas. The diffuser 19 is provided between the exhaust valve 7 and the gas outflow port 18 of the fuel generating device 100. With this configuration, fluctuations in the amount of hydrogen supplied from the exhaust valve 7 side to the diffuser 19 can be absorbed by the diffuser 19, and this helps reduce fluctuations in the amount of hydrogen supplied via the gas outflow port 18 of the fuel generating device 100 to outside the fuel generating device 100 (the gas inflow side of the fuel cell portion 2) (see FIG. 9). In FIG. 9, the amount of hydrogen supplied via the gas outflow port 18 of the fuel generating device 100 to outside the fuel generating device 100 (the gas inflow side of the fuel cell portion 2) in this embodiment is represented by a solid line, and the amount of hydrogen supplied via the gas outflow port 18 to outside the fuel generating device 100 (the gas inflow side of the fuel cell portion 2) in the first embodiment is represented by a broken lime. As will be seen from FIG. 9, even when the amount of hydrogen supplied via the gas outflow port to the outside fluctuates as the exhaust valve 7 is opened and closed periodically (broken line), it is possible to reduce fluctuations in the amount of hydrogen supplied to the gas inflow side of the fuel cell portion 2 (solid line), and thereby stabilize the amount of electric power generated by the fuel cell portion 2.

In this embodiment, as in the first embodiment, the exhaust valve 7 switches between a degree of opening corresponding to the fully open state and a degree of opening corresponding to the fully closed state.

An example of the configuration of the diffuser 19 is shown in FIG. 10. In FIG. 10, the flow of gas is schematically indicated by arrows. In the configuration example shown in FIG. 10, the diffuser 19 comprises an expansion chamber 22 provided with a gas inflow port 20 and a gas outflow port 21.

The flow passage cross-sectional area of the expansion chamber 22 (i.e., the cross-sectional area of the expansion chamber 22 perpendicular to the travel direction of the gas that flows into the gas inflow port 20) is larger than the flow passage cross-sectional area of the gas inflow port 20 (i.e., the cross-sectional area of the gas inflow port 20 perpendicular to the travel direction of the gas that flows into the gas inflow port 20), and is larger than the flow passage cross-sectional area of the gas outflow port 21 (i.e., the cross-sectional area of the gas outflow port 20 perpendicular to the travel direction of the gas that flows out of the gas outflow port 20).

The differences in flow passage cross-sectional area cause the gas pressure inside the expansion chamber 22 to be lower than the gas pressure inside the piping 6, and thus inside the expansion chamber 22, gas diffuses by spreading in all directions.

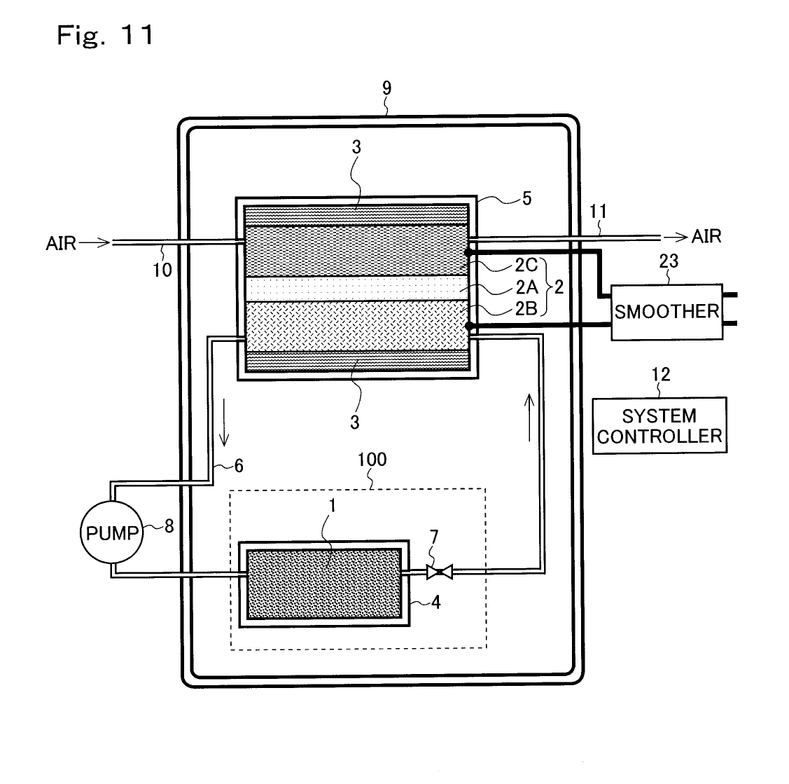

Instead of the diffuser 19, as shown in FIG. 11, a smoother 23 which smooths the electric power generated by the fuel cell portion 2 may be provided. With this configuration, it is not possible to reduce fluctuations in the amount of hydrogen supplied via the gas outflow port 18 of the fuel generating device 100 to outside the fuel generating device 100 (the gas inflow side of the fuel cell portion 2), but it is possible, just as if by reducing those fluctuations, to stabilize the output voltage of the secondary battery-type fuel cell system.

The smoother 23 can be, for example, a low-pass filter with a cut-off frequency lower than the frequency of the fluctuation of the amount of hydrogen supplied via the gas outflow port 18 of the fuel generating device 100 to outside the fuel generating device 100 (the gas inflow side of the fuel cell portion 2).

A secondary battery-type fuel cell system according to the present invention may be provided with both a diffuser 19 and a smoother 23. With this configuration, it is possible to further stabilize the output voltage of the secondary battery-type fuel cell system.

### Third Embodiment

An outline configuration of a secondary battery-type fuel cell system according to a third embodiment of the present invention is, like an outline configuration of a secondary battery-type fuel cell system according to the first embodiment, shown in FIG. 1 Likewise, a configuration of the fuel generating device 100 in this embodiment is, like a configuration of the fuel generating device 100 in the first embodiment, shown in FIG. 2.

However, in this embodiment, unlike in the first embodiment, the degree of opening of the exhaust valve 7 is switched between a degree of opening corresponding to a fully open state and a degree of opening corresponding to a partly open state. The switching can be achieved, for example, by using, as the exhaust valve 7, a controllable valve and operating it under the control of the system controller 12, or by using a pressure relief valve which remains in a partly open state when the pressure difference between the inlet and outlet ends is less than a predetermined value and which goes into a fully open state when the difference becomes equal to or greater than the predetermined value.

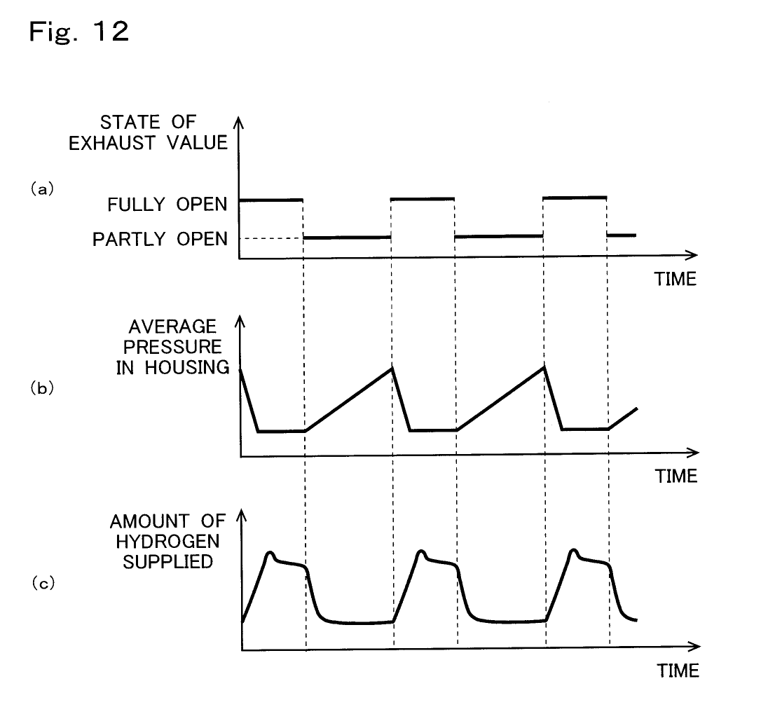

In this embodiment, the state of the exhaust valve 7, the average pressure in the housing 4, and the amount of hydrogen supplied via the gas outflow port 18 to the outside are as shown in FIGS. 12(a), 12(b), and 12(c) respectively.

In this embodiment, unlike in the first embodiment, there is no time span in which the amount of hydrogen supplied via the gas outflow port 18 of the fuel generating device 100 to outside the fuel generating device 100 (the gas inflow side of the fuel cell portion 2) becomes zero. Thus, compared with the first embodiment, this embodiment helps reduce fluctuations in the amount of hydrogen supplied via the gas outflow port 18 of the 100 to outside the fuel generating device 100 (the gas inflow side of the fuel cell portion 2), and also helps prevent damage to the electrodes and electrolyte of the fuel cell portion 2 resulting from fuel gas running out, contributing to enhanced durability of the fuel cell portion 2.

### Fourth Embodiment

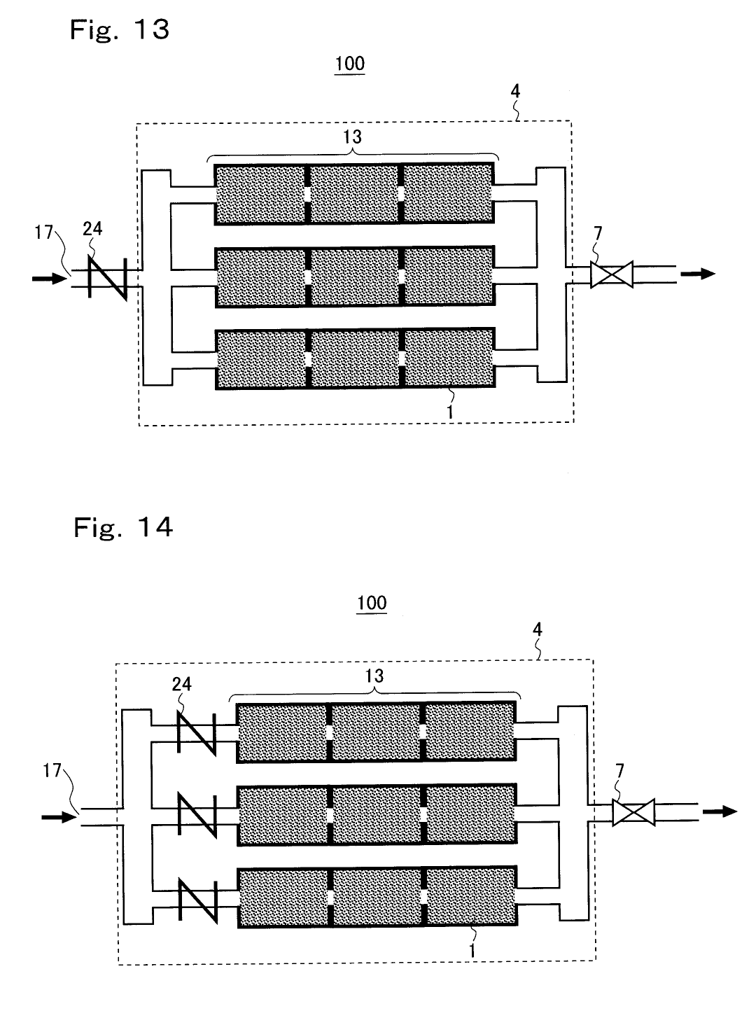

An outline configuration of a secondary battery-type fuel cell system according to a fourth embodiment of the present invention is, like an outline configuration of a secondary battery-type fuel cell system according to the first embodiment, shown in FIG. 1. However, a configuration of the fuel generating device 100 in this embodiment, unlike a configuration of the fuel generating device 100 in the first embodiment, is shown in FIG. 13.

In this embodiment, the degree of opening of the exhaust valve 7 is switched between a degree of opening corresponding to a fully open state and a degree of opening corresponding to a fully closed state or a partly open state.

Compared with the fuel generating device 100 in the first embodiment, the fuel generating device 100 in this embodiment is further provided with a check valve 24. The check valve 24 is provided between the gas inflow port 17 of the fuel generating device 100 and the housing 4. Providing the check valve 24 helps prevent gas from flowing in the reverse direction via the gas inflow port 17 of the fuel generating device 100 to the gas outflow side of the fuel cell portion 2. This ensures a reliable and quick rise in the average pressure in the housing 4 when the exhaust valve 7 has a degree of opening corresponding to the fully closed state or the partly open state. Thus, it is possible to generate a further increased amount of fuel gas.

Instead of the configuration shown in FIG. 13, a configuration as shown in FIG. 14 may be adopted where the sub-housings 13 are each provided with a check valve 24 at the gas inflow side.

### Fifth Embodiment

An outline configuration of a secondary battery-type fuel cell system according to a fifth embodiment of the present invention differs greatly, in that it is provided with three housings 4, from an outline configuration of a secondary battery-type fuel cell system according to the first embodiment, but except for the fuel generating device 100, is still as shown, like that of the secondary battery-type fuel cell system according to the first embodiment, in FIG. 1. The number of housings may be two or less, or four or more.

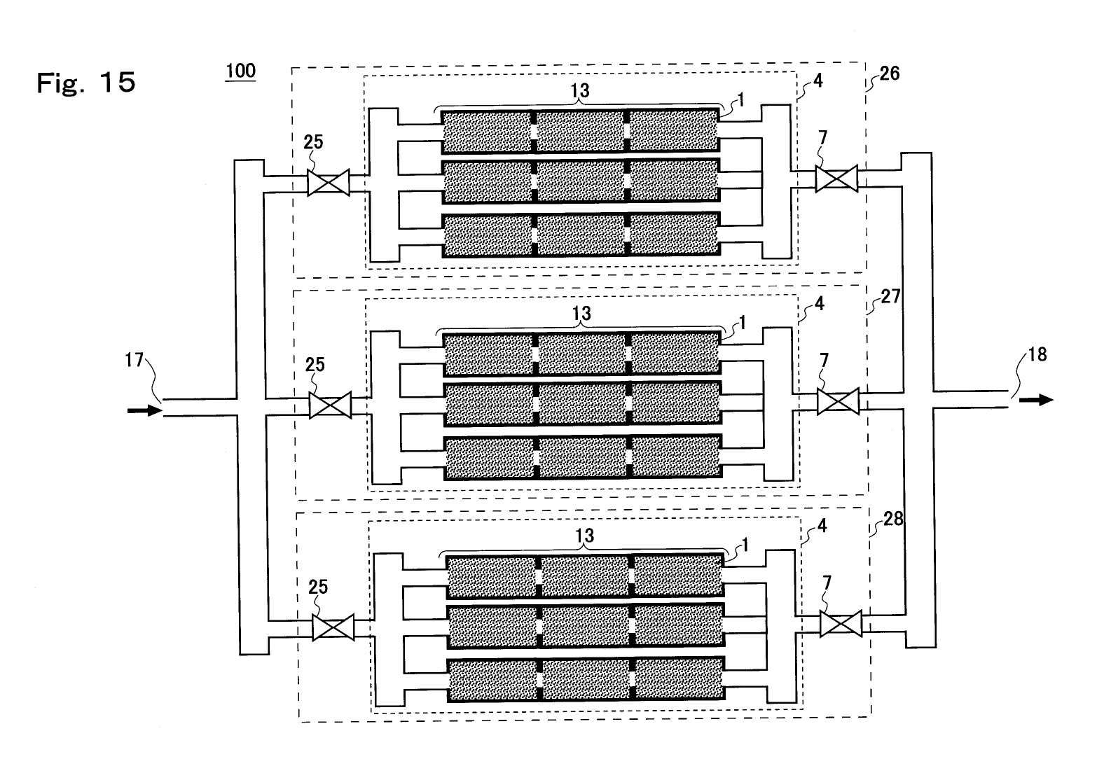

In this embodiment, the fuel generating device 100 has a configuration as shown in FIG. 15; that is, it has a first unit 26, a second unit 27, and a third unit 28 connected in parallel between the gas inflow port 17 and the gas outflow port 18, and those units each have a suction valve 25, a housing 4, and an exhaust valve 7 connected in series.

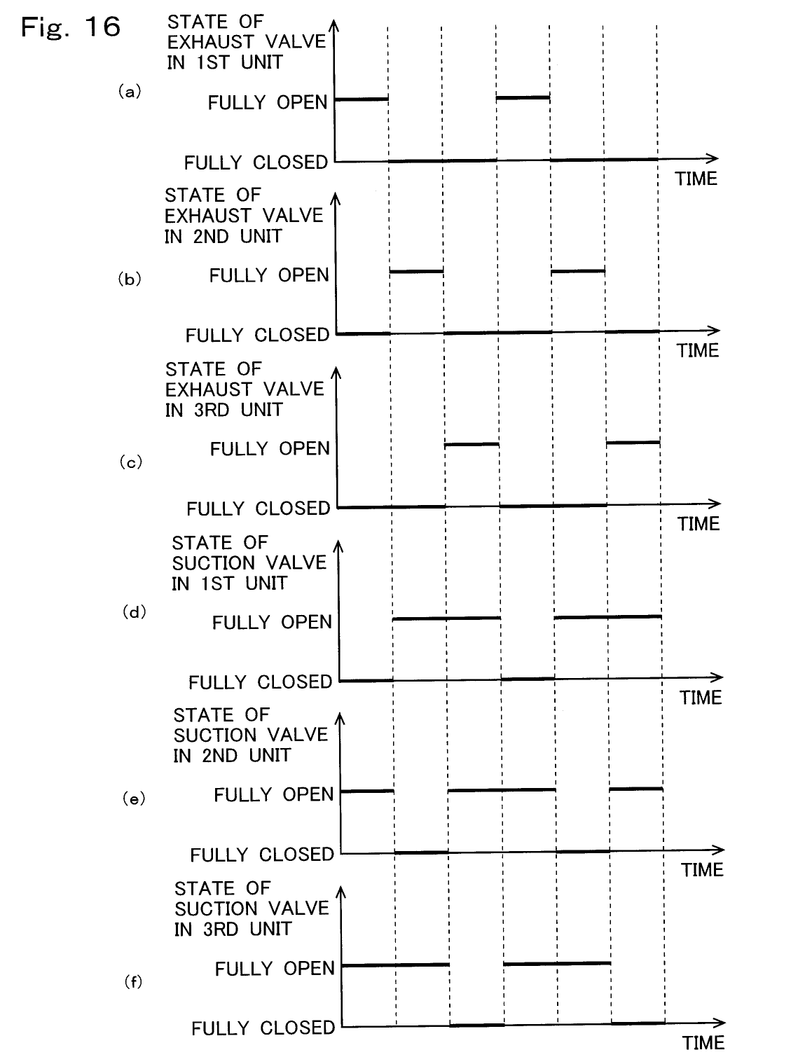

In this embodiment, the exhaust valve 7 is switched between a degree of opening corresponding to a fully open state and a degree of opening corresponding to a fully closed state, and in addition the system controller 12 so controls that a unit of which the exhaust valve 7 is in the fully open state is switched cyclically (see FIG. 16(a) to (c)). The exhaust valve 7 may have, instead of a degree of opening corresponding to a fully closed state, a degree of opening corresponding to a partly open state.

Bringing into the fully open state the suction valve 25 of a unit of which the exhaust valve 7 has a degree of opening corresponding to the fully open state causes gas to flow concentratedly through the unit of which the exhaust valve 7 has a degree of opening corresponding to the fully open state; this may hamper a rise in the average pressure in the housing 4 in a unit of which the exhaust valve 7 has a degree of opening corresponding to the fully closed state.

As a solution, in this embodiment, the suction valve 25 of a unit of which the exhaust valve 7 has a degree of opening corresponding to the fully open state is brought into the fully closed state (see FIG. 16(a) to (f)) so as to reliably raise the average pressure in the housing 4 in a unit of which the exhaust valve 7 has a degree of opening corresponding to the fully closed state. During a period in which, as shown in FIG. 16(a), the exhaust valve 7 of the first unit is fully open, the suction valve 25 of the first unit is in the fully closed state as shown in FIG. 16(d). During the same period, the exhaust valves 7 of the second and third units are in the fully closed state as shown in FIGS. 16(b) and (c), and the suction valves 25 of the second and third units are in the fully open state as shown in FIGS. 16(e) and (f). During a subsequent period, the exhaust valve 7 of the second unit is fully open (FIG. 16(b)), and the suction valve 25 of the second unit is in the fully closed state (FIG. 16(d)). During the same period, the exhaust valves 7 of the first and third units are in the fully closed state (FIGS. 16(a) and (c)), and the suction valves 25 of the first and third units are in the fully open state (FIGS. 16(d) and (f)). In this way, the system controller 12 so controls that, among the plurality of units, a unit of which the exhaust valve 7 has a degree of opening corresponding to the fully open state and a unit of which the exhaust valve 7 has a degree of opening corresponding to the fully closed state are switched cyclically such that the suction valve 25 of a unit of which the exhaust valve 7 has a degree of opening corresponding to the fully open state is in the fully closed state and that the suction valve 25 of a unit of which the exhaust valve 7 has a degree of opening corresponding to the fully closed state is in the fully open state. Incidentally, in a unit where the exhaust valve 7 has just switched from the fully closed state to the fully open state and the suction valve 25 has just switched from the fully open state to the fully closed state, the average pressure in the housing 4 is raised, and thus there is a large difference between the pressure there and the pressure at the outlet side of the exhaust valve 7; thus, for a while after the switching, hydrogen can be discharged.

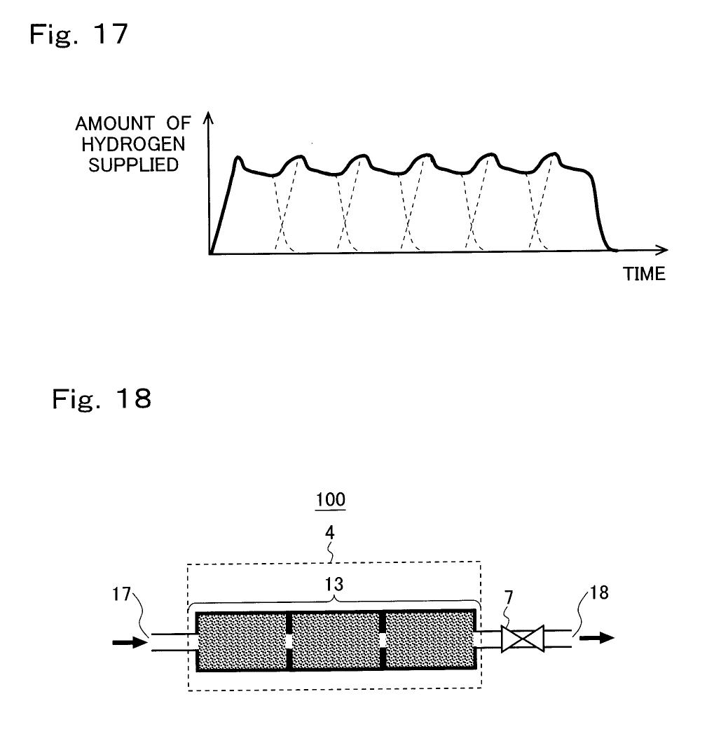

In this embodiment, hydrogen is discharged cyclically from one unit after another, and this helps reduce fluctuations in the amount of hydrogen supplied via the gas outflow port 18 of the fuel generating device 100 to outside the fuel generating device 100 (the gas inflow side of the fuel cell portion 2) (see FIG. 17). In FIG. 17, the amount of hydrogen supplied via the gas outflow port 18 of the fuel generating device 100 to outside the fuel generating device 100 (the gas inflow side of the fuel cell portion 2) is represented by a solid line, and the amount of hydrogen discharged from each unit is represented by a broken line.

Moreover, in the fuel generating device 100 according to this embodiment, by bringing both the suction valve 25 and the exhaust valve 7 into the fully closed state, it is possible to put a particular unit out of operation during maintenance. Also with the suction valve 25, the states between which it is switched may include not only a fully open state and a fully closed state but any other state (e.g. a partly open state)

### Modifications and Variations

In the embodiments described above, a solid oxide electrolyte is used for the electrolyte membrane 2A of the fuel cell portion 2 so that water is generated at the fuel electrode 2B during power generation. This configuration, since water is produced at the side where the fuel generating member 1 is provided, is advantageous in simplifying the device and reducing its size. On the other hand, as in the fuel cell disclosed in JP-A-2009-99491, a solid polymer electrolyte that passes hydrogen ions may be used for the electrolyte membrane 2A of the fuel cell portion 2. However, in that case, since water is produced at the air electrode 2C which is the oxidant electrode of the fuel cell portion 2 during power generation, a passage for directing the water to the fuel generating member 1 can be provided. Although in the embodiments described above a single fuel cell portion 2 engages in both generation of electric power and electrolysis of water, a configuration is also possible where a fuel cell (e.g., a solid oxide fuel cell dedicated to power generation) and a water electrolysis device (e.g., a solid oxide fuel cell dedicated to electrolysis of water) are connected in parallel in a gas passage with respect to the fuel generating member 1.

Although in the embodiments described above, hydrogen is used as the fuel gas for the fuel cell portion 2, any reductant gas other than hydrogen, such as carbon monoxide or a hydrocarbon, may instead be used as the fuel gas for the fuel cell portion 2.

Although in the embodiments described above, air is used as the oxidant gas, any gas other than air may instead be used as the oxidant gas.

Unless inconsistent, features from different embodiments or modified examples described above can be implemented in combination. For example, part of an embodiment (e.g., a state of the exhaust valve 7) may be replaced with part of another embodiment (e.g., a state of the exhaust valve 7). For example, in the fifth embodiment, of the plurality of units, while one or some are switched between a fully open state and a fully closed state, the other can be switched between a fully open state and a partly open state as in the third embodiment.

Although in the embodiments described above, the exhaust valve 7 is switched between two states, it may instead be switched among three or more states (e.g., a fully open state, a partly open state, and a fully closed state).

Although in the embodiments described above, the housing 4 has a plurality of sub-housings 13, and these sub-housings 13 are connected in parallel, the housing 4 does not necessarily have to have a plurality of sub-housings 13, for example, as shown in FIG. 18. With that configuration, when the exhaust valve 7 is in a fully closed state, due to the oxidant gas that is supplied to the housing 4 via the gas inflow port 17 from the outside (the gas outflow side of the fuel cell portion 2), the average pressure in the single sub-housing 13 rises, and the gas pervades parts inside the sub-housing 13 where the pressure loss is large; this increases the total amount of hydrogen supplied via the gas outflow port 18 to the outside. Although in FIG. 18 three containers are connected in series, the housing 4 may instead comprise a single container.

Disclosed herein is a fuel generating device which generates fuel gas as a reductant gas through an oxidation reaction with an oxidant gas, and the device includes: a gas inflow port through which the oxidant gas is supplied from the outside; a gas outflow port through which the fuel gas is supplied to the outside; a fuel generating member which generates the fuel gas through the oxidation reaction with the oxidant gas; a housing which is provided between the gas inflow port and the gas outflow port and which houses the fuel generating member; and an exhaust valve which is provided between the housing and the gas outflow port. Here, the degree of opening of the exhaust valve is varied periodically among a different degrees of opening including a first degree of opening and a second degree of opening smaller than the first degree of opening such that a rise in the pressure inside the housing due to the oxidant gas being supplied to the housing via the gas inflow port from the outside is larger when the exhaust valve has the second degree of opening than when the exhaust valve has the first degree of opening (a first configuration).

In the fuel generating device of the first configuration described above, preferably, the housing has a plurality of sub-housings each housing the fuel generating member, and the plurality of sub-housings are connected in parallel (a second configuration).

In the fuel generating device of the first or second configuration described above, preferably, there is further provided a check valve between the gas inflow port and the housing (a third configuration).

In the fuel generating device of the second configuration described above, preferably, the housing has check valves one at the gas inflow side of each of the sub-housings (a fourth configuration).

In the fuel generating device of any one of the first to fourth configurations described above, preferably, there is further provided a gas diffuser between the exhaust valve and the gas outflow port (a fifth configuration).

In the fuel generating device of any one of the first to fifth configurations described above, preferably, the first degree of opening is a degree of opening corresponding to a fully open state and the second degree of opening is a degree of opening corresponding to a partly open state (a sixth configuration).

In the fuel generating device of any one of the first to fifth configurations described above, preferably, the first degree of opening is a degree of opening corresponding to a fully open state and the second degree of opening is a degree of opening corresponding to a fully closed state (a seventh configuration).

In the fuel generating device of any one of the first to seventh configurations described above, preferably, there is further provided a suction valve between the gas inflow port and the housing, and there are provided a plurality of units each comprising the suction valve, the housing, and the exhaust valve, the plurality of units being connected in parallel (an eighth configuration).

In the fuel generating device of the eighth configuration described above, preferably, among the plurality of units, a unit of which the exhaust valve has the first degree of opening and a unit of which the exhaust valve has the second degree of opening are switched cyclically such that the suction valve of a unit of which the exhaust valve has the first degree of opening is in the fully closed state and that the suction valve of a unit of which the exhaust valve has the second degree of opening is in the fully open state (a ninth configuration).

In the fuel generating device of any one of the first to ninth configurations described above, preferably, there is further provided a controller which controls the degree of opening of the exhaust valve or of the suction valve (a tenth configuration).

Also disclosed herein is a fuel cell system that includes: the fuel generating device of any one of the first to tenth configurations described above; and a fuel cell device which generates electric power by using fuel gas supplied from the fuel generating device (an eleventh configuration).

In the fuel cell system of the eleventh configuration described above, preferably, there is further provided a smoother which smooths the electric power generated by the fuel cell device (a twelfth configuration).

With a fuel generating device disclosed herein, the rise in the pressure in the housing due to the oxidant gas being supplied to the housing via the gas inflow port from the outside is larger when the exhaust valve has the second degree of opening than when the exhaust valve has the first degree of opening. Accordingly, when the exhaust valve has the second degree of opening, the oxidant gas more easily pervades parts of the fuel generating member where the pressure loss is large for structural reasons. This allows effective use of parts of the fuel generating member where the pressure loss is large for structural reasons; it is thus possible to generate an increased amount of fuel gas, to prevent concentrated deterioration of parts of the hydrogen generating member where the pressure loss is small for structural reasons, and to enhance the durability of the fuel generating device.

With a fuel cell system disclosed herein, owing to the provision of the fuel generating device described above, the increased amount of fuel gas generated by the fuel generating device results in an increased battery capacity of the fuel cell system, and the enhanced durability of the fuel generating device results in an enhanced durability of the fuel cell system.

### LIST OF REFERENCE SIGNS

1 fuel generating member

2 fuel cell portion

2A electrolyte membrane

2B fuel electrode

2C air electrode

3 heater

4 housing

5 container

6, 10, 11 piping

7 exhaust valve

8 pump

9 heat-insulated container

12 system controller

13 sub-housing

14 container body

15 lid

16 fuel generating member pellet

17, 20 gas inflow port

18, 21 gas outflow port

19 diffuser

22 expansion chamber

23 smoother

24 check valve

25 suction valve

26 first unit

27 second unit

28 third unit

1. A fuel generating device which generates fuel gas as a reductant gas through an oxidation reaction with an oxidant gas, the device comprising:
a gas inflow port through which the oxidant gas is supplied from outside;
a gas outflow port through which the fuel gas is supplied to outside;
a fuel generating member which generates the fuel gas through the oxidation reaction with the oxidant gas;
a housing which is provided between the gas inflow port and the gas outflow port and which houses the fuel generating member; and
an exhaust valve which is provided between the housing and the gas outflow port,
wherein
a degree of opening of the exhaust valve is varied periodically among at least two different degrees of opening including a first degree of opening and a second degree of opening smaller than the first degree of opening such that
a rise in pressure inside the housing due to the oxidant gas being supplied to the housing via the gas inflow port from outside is larger when the exhaust valve has the second degree of opening than when the exhaust valve has the first degree of opening.

2. The fuel generating device according to claim 1,
wherein the housing has a plurality of sub-housings, each sub-housing housing the fuel generating member, and the plurality of sub-housings are connected in parallel.

3. The fuel generating device according to claim 1, further comprising:
a check valve which is provided between the gas inflow port and the housing.

4. The fuel generating device according to claim 2,
wherein the housing has check valves one at a gas inflow side of each of the sub-housings.

5. The fuel generating device according to claim 1, further comprising:
a gas expansion portion which is provided between the exhaust valve and the gas outflow port.

6. The fuel generating device according to claim 1,
wherein the first degree of opening is a degree of a fully open state and the second degree of opening is a degree of a partly open state.

7. The fuel generating device according to claim 1,
wherein the first degree of a fully open state and the second degree of opening is a degree of a fully closed state.

8. The fuel generating device according to claim 1, further comprising:
a suction valve which is provided between the gas inflow port and the housing,
wherein there are provided a plurality of units, each unit comprising the suction valve, the housing, and the exhaust valve, and the plurality of units are connected in parallel.

9. The fuel generating device according to claim 8,
wherein among the plurality of units, a unit of which the exhaust valve has the first degree of opening and a unit of which the exhaust valve has the second degree of opening are switched cyclically such that the suction valve of a unit of which the exhaust valve has the first degree of opening is in the fully closed state and that the suction valve of a unit of which the exhaust valve has the second degree of opening is in the fully open state.

10. The fuel generating device according to claim 1, further comprising:
a controller which controls the degree of opening of the exhaust valve or of the suction valve.

11. A fuel cell system comprising:
a fuel generating device according to claim 1; and
a fuel cell device which generates electric power by using fuel gas supplied from the fuel generating device.

12. The fuel cell system according to claim 11, further comprising:
a smoother which smooths the electric power generated by the fuel cell device.

13. A fuel generating device which generates fuel gas as a reductant gas through an oxidation reaction with an oxidant gas, the device comprising:
a gas inflow port through which the oxidant gas is supplied from outside;
a gas outflow port through which the fuel gas is supplied to outside;
a fuel generating member which contains metal fine particles and which generates the fuel gas through the oxidation reaction of the metal fine particles with the oxidant gas;
a housing which is provided between the gas inflow port and the gas outflow port and which houses the fuel generating member;
an exhaust valve which is provided between the housing and the gas outflow port; and
a gas diffuser which is provided between the exhaust valve and the gas outflow port,
wherein
a degree of opening of the exhaust valve is varied periodically among at least two different degrees of opening including a first degree of opening and a second degree of opening smaller than the first degree of opening such that
a rise in pressure inside the housing due to the oxidant gas being supplied to the housing via the gas inflow port from outside is larger when the exhaust valve has the second degree of opening than when the exhaust valve has the first degree of opening.
